(19) United States
(12) Patent Application Publication
(10) Pub. No.: US 2009/0222351 A1
(43) Pub. Date: Sep. 3, 2009

(54) System And Method For Obtaining Advertising Exposure Time

(75) Inventor: Honglong Wang, Shenzhen (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited, Shenzhen (CN)

(21) Appl. No.: 12/408,787

(22) Filed: Mar. 23, 2009

Related U.S. Application Data
(63) Continuation of application No. PCT/CN2007/070605, filed on Aug. 31, 2007.

(30) Foreign Application Priority Data
Sep. 26, 2006 (CN) 200610127076.6

(51) Int. Cl. G06Q 30/00; G06F 17/00

(52) U.S. Cl. 705/14; 235/377

(57) ABSTRACT

The embodiments of the present invention disclose a system for obtaining advertising exposure time, which includes: one or more clients, adapted to calculate exposure time of playing an advertisement each time by the client, and send an identity of the advertisement and the exposure time of playing the advertisement each time to an advertising server; the advertising server, adapted to obtain total exposure time of the advertisement according to the identity of the advertisement and the exposure time of playing the advertisement each time sent by the client. The embodiments of the present invention also disclose a method for obtaining advertising exposure time.

### CROSS-REFERENCE TO RELATED APPLICATIONS

This application is a continuation of International Application No. PCT/CN2007/070605, filed Aug. 31, 2007. This application claims the benefit and priority of Chinese Application No. 200610127076.6, filed Sep. 26, 2006. The entire disclosures of each of the above applications are incorporated herein by reference.

### FIELD

The present disclosure relates to the field of Internet advertising technology, especially to a system and a method for obtaining advertising exposure time.

### BACKGROUND

This section provides background information related to the present disclosure which is not necessarily prior art.

With the development of Internet, people can perform more and more activities on Internet, not only simply browsing web pages, but also performing instant messaging, online games, etc. on Internet. The popularity of Internet technology results in the development of Internet advertising technology. The Internet advertising technology generally adopts advertising server-client architecture, the advertising server provides advertising contents, and the client downloads the advertising contents and plays the advertising contents for users.

In the Internet advertising technology, the obtaining of advertising exposure time becomes an essential technical problem. The advertising exposure time means the time during which an advertisement is displayed for users. In conventional technologies, there are generally two methods to obtain the advertising exposure time as follows:

A first conventional technique is a sampling statistics method.

This method mainly includes: sampling a certain number of users, conducting a questionnaire survey among the users, statistically calculating the advertising exposure time according to effective replies, and thus getting the advertising exposure time. Because this method relies on the users to a large extent and advertising exposure time provided in the replies of the users are not always accurate, the result of this method has a rather error, and can not reflect the exact advertising exposure time accurately.

A second conventional technique is a method based on average game time estimation. This method is usually applied to an online-game advertisement. For example, a certain online game is played for 10,000 games on average every day, each game lasts for 1.5 minutes on average and the advertisement is played for 4 game players, so it is estimated according to this method that everyday the advertising exposure time is: 10000×1.5×4=60000 minutes. However, during practical course of an online game, the advertising exposure time is not equal to the lasting time of the online game. For example, when one game player is waiting for another game player before the online game starts, the advertisement is already exposed to the game player though the online game is not played actually. Therefore, this method cannot obtain the advertising exposure time accurately.

### SUMMARY

This section provides a general summary of the disclosure, and is not a comprehensive disclosure of its full scope or all of its features.

Embodiments of the present invention provide a system for obtaining advertising exposure time, so as to obtain the advertising exposure time more accurately. The embodiments of the present invention also provide a method for obtaining advertising exposure time.

A system for obtaining advertising exposure time includes:

one or more clients, adapted to calculate exposure time of playing an advertisement each time by the client, and send an identity of the advertisement and the exposure time of playing the advertisement each time to an advertising server;

the advertising server, adapted to obtain total exposure time of the advertisement according to the identity of the advertisement and the exposure time of playing the advertisement each time sent by the client.

A method for obtaining advertising exposure time includes:

calculating, by a client, exposure time of playing an advertisement each time by the client, and sending an identity of the advertisement and the exposure time of playing the advertisement each time to an advertising server;

obtaining, by the advertising server, total exposure time of the advertisement according to the identity of the advertisement and the exposure time of playing the advertisement each time sent by the client.

It can be seen from the above scheme that, in the embodiments of the present invention the exposure time of playing the advertisement each time is calculated when the advertisement is played each time, and then the identity of the played advertisement and the exposure time of playing the advertisement each time corresponding to the identity are sent to the advertising server, so that the advertising server can obtain the exposure time of playing the advertisement each time accurately, thus further exactly obtain total exposure time of the advertisement by statistically calculating the exposure time of playing the advertisement each time.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating the architecture of a system in accordance with a first embodiment of the present invention.

FIG. 2 is a flowchart illustrating a method in accordance with the first embodiment of the present invention.

FIG. 3 is a schematic diagram illustrating the architecture of a system in accordance with a second embodiment of the present invention.

FIG. 4 is a schematic diagram of playing an advertisement in an online game in accordance with the second embodiment of the present invention.

FIG. 5 is a flowchart illustrating a method in accordance with the second embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In order to make the object, technical scheme and advantages of the present invention clearer, the present invention will be further described in detail hereinafter with reference to the embodiments.

In the embodiments of the present invention, when a client plays an advertisement for a user each time, the client calculates exposure time of playing the advertisement each time, and sends an identity of the played advertisement and the exposure time of playing the advertisement each time corresponding to the identity to an advertising server. The advertising server obtains total exposure time of the advertisement according to the identity and the exposure time of playing the advertisement each time.

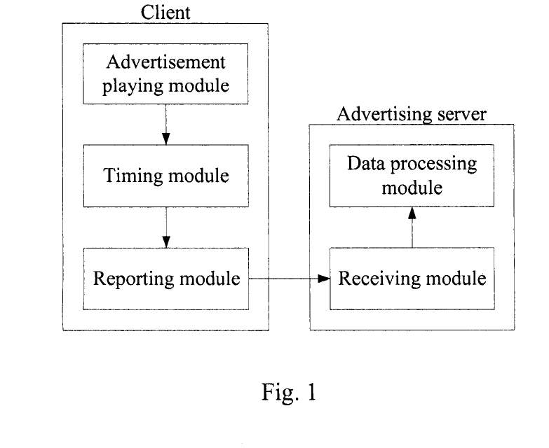

FIG. 1 is a schematic diagram illustrating the architecture of a system for obtaining advertising exposure time in accordance with a first embodiment of the present invention.

With reference to FIG. 1, this system includes a client and an advertising server. Although only one client is showed in FIG. 1, the system may include more than one client obviously.

The client is adapted to play an advertisement, calculate the exposure time of playing the advertisement each time, and sends an identity of the played advertisement and the exposure time of playing the advertisement each time corresponding to the identity to the advertising server. The advertising server is adapted to receive the identity and the exposure time of playing the advertisement each time sent by each client, and statistically calculate total exposure time of the advertisement.

As shown in FIG. 1, the client may include an advertisement playing module, a timing module and a reporting module. The advertisement playing module is adapted to play an advertisement for a user, e.g. display the video of the advertisement on a display device. If the advertisement comprises audio, the advertisement playing module can play the audio through an audio device, so as to expose the advertisement to the user. The timing module is adapted to calculate the exposure time of playing the advertisement this time when the advertisement playing module plays the advertisement, and send the identity of the played advertisement and the exposure time of playing the advertisement this time corresponding to the identity to the reporting module. The reporting module sends the identity and the exposure time of playing the advertisement this time to the advertising server.

The timing module may include a timer. The timing module starts the timer when the advertisement playing module starts playing an advertisement, stops the timer when the advertisement playing module stops playing the advertisement, calculates the time difference of the timer, and takes the time difference as the exposure time of playing the advertisement this time.

The timing module may also include a timer module. The timing module records the current time of the timer module as start time when the advertisement playing module starts playing an advertisement, records the current time of the timer module as end time when the advertisement playing module stops playing the advertisement, calculates the time difference between the start time and the end time, and takes the time difference as the exposure time of playing the advertisement this time.

With reference to FIG. 1, the advertising server may include a receiving module and a data processing module.

The receiving module is adapted to receive the identity and the exposure time of playing the advertisement each time corresponding to the identity from each client, and send the identity and the exposure time of playing the advertisement each time to the data processing module. According to each identity and the exposure time of playing the advertisement each time corresponding to the advertisement, the data processing module accumulates the exposure time of playing the advertisement each time corresponding to the same identity, so as to obtain total exposure time corresponding to this identity, i.e. the total exposure time of the advertisement.

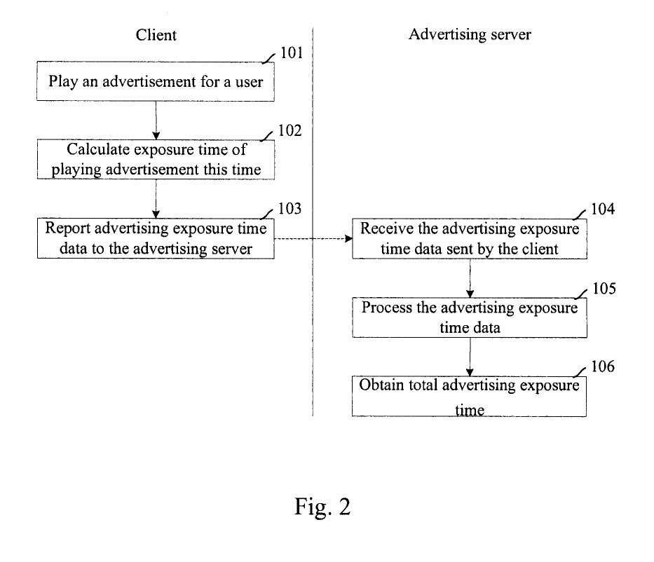

FIG. 2 is a flowchart illustrating a method in accordance with the first embodiment of the present invention. With reference to FIG. 2, the procedure of the first embodiment of the present invention includes the following blocks.

Block 101: The advertisement playing module plays an advertisement for a user.

Block 102: The timing module calculates the exposure time of playing the advertisement this time, e.g. calculates the exposure time through the timer or the timer module, and then sends the identity of the played advertisement and the exposure time of playing the advertisement this time corresponding to the identity to the reporting module.

Block 103: The reporting module sends such advertising time data as the identity and the exposure time of playing the advertisement this time corresponding to the identity to the advertising server.

Block 104: At the advertising server, the receiving module receives the identity and the exposure time of playing the advertisement this time corresponding to the identity from each client, and then sends the identity and the exposure time of playing the advertisement this time corresponding to the identity to the data processing module.

Blocks 105 to 106: According to each identity and the exposure time of playing the advertisement each time corresponding to the identity, the data processing module accumulates the exposure time of playing the advertisement each time corresponding to the same identity, so as to obtain total exposure time corresponding to the identity, i.e. the total exposure time of the advertisement.

It can be seen from the technical scheme of the first embodiment that, because each time the advertisement is played, the exposure time is calculated and sent to the advertising server. The advertising server may accurately obtain the exposure time of playing the advertisement each time, thus further exactly obtain the total exposure time of the advertisement. Moreover, the first embodiment also provides more than one method for calculating exposure time of playing the advertisement each time, thus further guarantees the accuracy of obtaining the exposure time.

The present invention can also be applied to the online-game field. In such application, the client is an online-game client, which can implement online-game functions and play an advertisement when an online game is played.

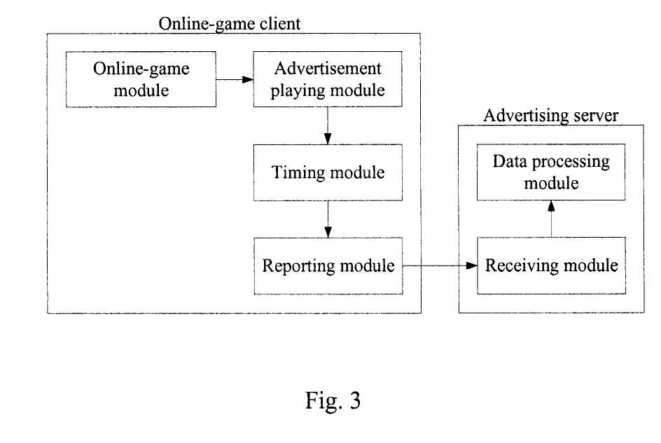

FIG. 3 is a schematic diagram illustrating the architecture of a system in accordance with a second embodiment of the present invention.

With reference to FIG. 3, the system includes an online-game client and an advertising server. Although only one online-game client is shown in FIG. 3, the system may include more than one online-game client obviously. The online-game client is adapted to run an online game, play an advertisement when the online game is run, calculate the exposure time of playing the advertisement each time, and send the identity of the played advertisement and the exposure time of playing the advertisement each time corresponding to the identity to the advertising server. The advertising server is adapted to receive the identity and the exposure time of playing the advertisement each time corresponding to the identity sent by each client, and then calculate total exposure time of the advertisement.

As shown in FIG. 3, the online-game client includes an online-game module, an advertisement playing module, a timing module and a reporting module. The online-game module is adapted to run an online game, e.g. acquire online-game data from a game server and run the online game.

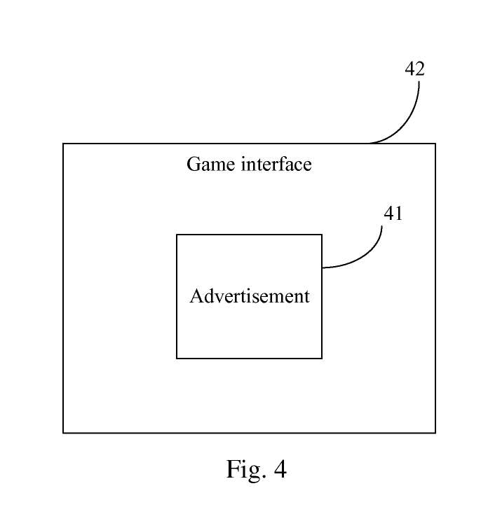

The advertisement playing module is adapted to play an advertisement for a user when the user runs the online game, for example, play the advertisement for the user when the game starts, and stop playing the advertisement when the game is over, the game segment is over or the game is interrupted, so as to expose the advertisement to the user. The game segment refers to a situation in which the online-game module quits from a certain running game while other users continue this game. As shown in FIG. 4, when a certain online game is run, the advertisement playing module plays an advertisement 41 in the middle of game interface 42 by way of display.

When the advertisement playing module plays the advertisement, the timing module calculates the exposure time of playing the advertisement this time, and sends the identity of the played advertisement the exposure time of playing the advertisement this time corresponding to the identity to the reporting module. The reporting module sends the identity and the exposure time of playing the advertisement this time corresponding to the identity to the advertising server.

As in the first embodiment, the timing module may also include a timer and/or a timer module, which is not illustrated hereby.

With reference to FIG. 3, the advertising server may include a receiving module and a data processing module. The receiving module is adapted to receive the identity and the exposure time of playing the advertisement each time corresponding to the identity from each online-game client, and sends the identity and the exposure time of playing the advertisement each time corresponding to the identity to the data processing module. According to each identity and the exposure time of playing the advertisement each time corresponding to the identity, the data processing module accumulates the exposure time of playing the advertisement each time corresponding to the same identity, so as to obtain total exposure time corresponding to the identity, i.e. the total exposure time of the advertisement.

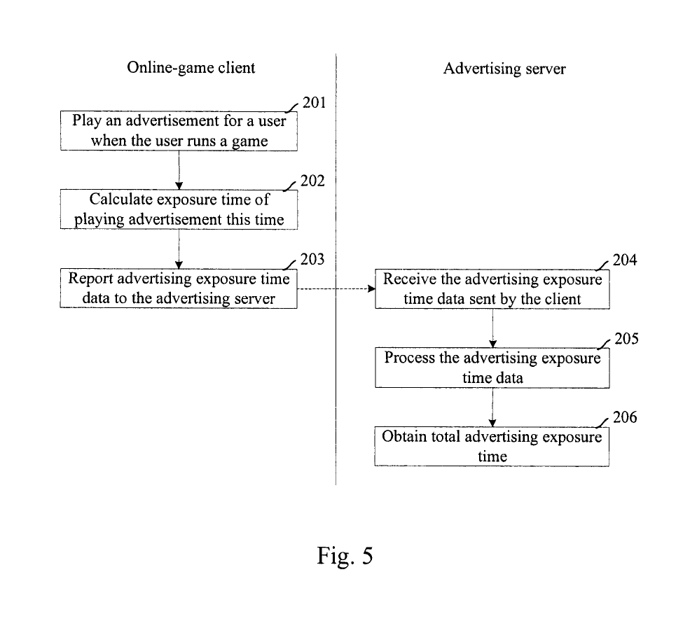

FIG. 5 is a flowchart illustrating a method in accordance with the second embodiment of the present invention. With reference to FIG. 5, a procedure of the second embodiment of the present invention includes the following blocks.

Block 201: During a course that the online-game module runs an online game, e.g. during a game of online game or a game segment, the advertisement playing module plays an advertisement for a user.

Block 202: The timing module calculates exposure time of playing the advertisement this time, e.g. calculates the exposure time through the timer or the timer module, and sends the identity of the played advertisement and the exposure time of playing the advertisement this time corresponding to the identity to the reporting module.

Block 203: The reporting module sends such advertising time data as the identity and the exposure time of playing the advertisement this time corresponding to the identity to the advertising server.

In this block, the reporting module may also report other advertising time data such as user property information and area information of the online-game client corresponding to the identity of the played advertisement to the advertising server. The user property information may include the age, gender, occupation of the user, etc.

Block 204: At the advertising server, the receiving module receives from each online-game client the identity of the played advertisement, the exposure time of playing the advertisement each time corresponding to the identity, the user property information and area information of the online-game client, etc, and sends the received information to the data processing module.

Blocks 205 to 206: According to each identity and the exposure time of playing the advertisement each time corresponding to the identity, the data processing module accumulates the exposure time of playing the advertisement each time corresponding to the same identity, so as to obtain total exposure time corresponding to the identity, i.e. the total exposure time of the advertisement.

In addition, the data processing module may also obtain total exposure time corresponding to different user properties according to the user property information of the same identity or different identities. Taking the age as an example, the data processing module may accumulate the advertising exposure time corresponding to each age phase in the same identity, so as to obtain total advertising exposure time corresponding to each age phase for this advertisement. The result may be further illustrated in a diagram, e.g. a diagram with the age as the x-axis and the total advertising exposure time as the y-axis. Or, the data processing module may accumulate the advertising exposure time corresponding to each age phase in multiple identities, so as to obtain total advertising exposure time corresponding to each age phase for these advertisements. The result may be further illustrated in a diagram, e.g. a diagram with the age as the x-axis and the total advertising exposure time as the y-axis. In the same way, the data processing module may also calculate total advertising exposure time of one or more advertisements corresponding to different area information according to the area information of online-game clients.

The foregoing are only preferred embodiments of the present invention and are not for use in limiting the protection scope of the present invention. Any modification, equivalent replacement and improvement made within the scope of the present invention should be covered under the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for obtaining advertising exposure time, comprising:
one or more clients, adapted to calculate exposure time of playing an advertisement each time by the client, and send an identity of the advertisement and the exposure time of playing the advertisement each time to an advertising server;
the advertising server, adapted to obtain total exposure time of the advertisement according to the identity of the advertisement and the exposure time of playing the advertisement each time sent by the client.

2. The system of claim 1, wherein the client comprises:
an advertisement playing module, adapted to play the advertisement;
a timing module, adapted to calculate the exposure time of playing the advertisement each time when the advertisement playing module plays the advertisement, and send the identity of the advertisement and the exposure time of playing the advertisement each time to a reporting module;
the reporting module, adapted to send the identity of the advertisement and the exposure time of playing the advertisement each time to the advertising server.

3. The system of claim 2, wherein the timing module comprises a timer; the timing module is adapted to start the timer when starting playing the advertisement each time, stop the timer when stopping playing the advertisement each time, calculate time difference of the timer, and take the time difference as the exposure time of playing the advertisement each time.

4. The system of claim 2, wherein the timing module comprises a timer module; the timing module is adapted to record current time of the timer module as start time when starting playing the advertisement each time, record current time of the timer module as end time when stopping playing the advertisement each time, calculate time difference of the end time and the start time, and take the time difference as the exposure time of playing the advertisement each time.

5. The system of claim 2, wherein the client is an online-game client comprising an online-game module, and the online-game module is adapted to run an online game;
the advertisement playing module is further adapted to play the advertisement when the online-game module runs the online game.

6. A method for obtaining advertising exposure time, comprising:
calculating, by a client, exposure time of playing an advertisement each time by the client, and sending an identity of the advertisement and the exposure time of playing the advertisement each time to an advertising server;
obtaining, by the advertising server, total exposure time of the advertisement according to the identity of the advertisement and the exposure time of playing the advertisement each time sent by the client.

7. The method of claim 6, wherein calculating the exposure time of playing the advertisement each time by the client comprises:
calculating the exposure time of playing the advertisement each time according to start time of playing the advertisement each time and end time of playing the advertisement each time.

8. The method of claim 7, wherein calculating the exposure time of playing the advertisement each time according to the start time of playing the advertisement each time and the end time of playing the advertisement each time comprises one of:
starting, by the client, a timer when starting playing the advertisement each time, stopping the timer when stopping playing the advertisement each time, calculating time difference of the timer, and taking the time difference as the exposure time of playing the advertisement each time; and
recording, by the client, current time as start time when starting playing the advertisement each time, recording current time as end time when stopping playing the advertisement each time, calculating time difference between the start time and the end time, and taking the time difference as the exposure time of playing the advertisement each time.

9. The method of claim 6, wherein the client is an online-game client;
the method further comprises:
starting playing, by the online-game client, the advertisement when a game starts, and stopping playing the advertisement when the game is over, when a game segment is over or when the game is interrupted.

10. The method of claim 6, further comprising:
reporting, by the client, user property information corresponding to the identity of the advertisement and/or area information of the client to the advertising server;
calculating, by the advertising server, total exposure time of one or more advertisements corresponding to different user property information and/or different area information.
